(19) United States
(12) Patent Application Publication
(10) Pub. No.: US 2003/0212608 A1
(43) Pub. Date: Nov. 13, 2003

(54) Apparatus for and method of providing media programmes and advertising content to consumers

(76) Inventor: David Trevor Cliff, Bristol (GB)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/387,981

(22) Filed: Mar. 12, 2003

(30) Foreign Application Priority Data
Mar. 13, 2002 (GB) 0205882.4

(51) Int. Cl. G06F 17/60

(52) U.S. Cl. 705/26

(57) ABSTRACT

A system for supplying media provided by one or more suppliers to a number of consumers across a network through an intermediary comprises a supplier unit adapted to supply to the intermediary a “supply offer” price indicative of the price that the supplier is offering to supply a combination of media content and/or advertisements to consumers connected to the network and a consumer unit which is adapted to provide to the intermediary a “consume offer” price indicative of the price that the consumer is prepared to pay for a selection of media and advertisement. The intermediary is adapted to establish an auction between the supplier making “supply offers” and the consumer making “consume offers” to establish agreed transactions between a supplier and a consumer. A method of supplying media is also disclosed.

This invention relates to improvements in apparatus for providing media programmes and advertising content to consumers. It also relates to a method of providing such media to consumers.

At present, there a several different ways in which media programmes are provided by a provider to a consumer. By media programme we mean any pre-recorded or live programme such as a sports event, news, current affairs, comedy, drama, quiz show etc, which can be viewed and/or listened to by a consumer.

To get the media to a consumer the provider must own or at least have access to a transmission unit, such as a radio frequency transmitter, which sends “streamed” signals (e.g. television, radio, internet multimedia) across a suitable broadcast medium, such as through the air or along an electrical or optical cable, and the consumer must own or have access to a compatible receiver unit, such as a radio frequency antenna. A programme to be broadcast to the consumer is encoded into a format suitable to be uploaded to the transmitter and sent to the consumer's receiver across the medium. The receiver downloads the broadcast signal to a suitable decoder which passes the signal to a presentation unit, typically a television screen or monitor, if the media programme has a visual content, or perhaps simply to a loudspeaker where the programme contains only audio content.

All this usually occurs in real time with the programme being transmitted substantially at the same time as it is reproduced by the display such that a one-hour programme will take one hour to transmit. This is the format used for analogue television transmissions. In some cases, however, the programme may be transmitted in advance and replayed at a later time or transmitted in bursts across the transmission. This is a closer analogy to some of today's digital television services. In either case, the viewer generally cannot control the time at which they can view/listen to the programme.

In order to make a profit from supplying media programmes, the supplier must have a mechanism whereby the cost of supply is covered by the consumers or some other interested third party such as a sponsor or an advertiser. In general, it is fair to say that a conflict exists between the interests of the supplier who wants to maximise the profit from the supply of the programme and the consumer who wants to view the programme for the lowest price.

To date, several different methods of supply of programmes have been implemented. In a first method the consumer must pay a fixed fee to watch media broadcast by the supplier. This is the method by which the BBC transmits media, which is funded by a mandatory annual licence fee. The BBC is in fact non-profit making and so the revenue from the licence fee provides the sole source of revenue for commissioning programmes and buying the rights to events such as football matches.

In a second method the supplier does not (necessarily) charge the consumer a fee to watch or listen to programmes. Instead revenue is made by charging advertisers for advertisements presented in “slots”—typically 30 seconds long-between programmes and during breaks in programmes in which advertisements can be screened. The money from the advertisers pays for the programmes to be commissioned or bought and contributes to the supplier's profits. This has the advantage to the consumer that the broadcast is free but has the disadvantage that the consumer has no choice but to watch/listen to the adverts.

In a third model, which is similar to that used by the BBC, the viewer pays a fee but only for the right to view an individual programme such as a sports event, or perhaps for the right simply to access the service for a specified period of time. Again, the supplier will usually include advertisements within the programme to boost their revenue.

Many people dislike adverts and want only to watch or listen to their preferred programmes without being interrupted. The supplier, on the other hand, must tightly control the timing at which adverts are transmitted in order to capture the largest audience and hence to be able to charge the highest premium for advertising airtime.

In order to permit a customer to view programmes without having to watch the advertisements it is also known to provide a personal video recorder, which comprises a hard-drive onto which, many hours of transmission can be recorded. The customer can then play back the recording and fast-forward to skip the adverts. Obviously, this is a benefit to the consumer but poses a problem to the supplier that relies on advertisement income. If the advertiser is aware that customers are skipping their adverts they are less likely to pay for an advertisement slot.

Ultimately, many industry observers believe the increased use of personal video recorders will result in a reduction of the number of adverts matched by an increase in the use of product placement in the media programmes themselves.

It is an object of the present invention to provide apparatus for the supply of media and advertising content from a supplier to a customer, which ameliorates at least partially some of the problems presented in the prior art.

In accordance with a first aspect the invention provides a system for supplying media provided by one or more suppliers to a number of consumers across a network through an intermediary means comprising:

a supplier means which includes supply offer price means for providing to the intermediary a “supply offer” price indicative of the price that the supplier is offering to supply a combination of media content and/or advertisements to consumers connected to the network;

a consumer means which includes consume offer price means for providing to the intermediary means a “consume offer” price indicative of the price that the consumer is prepared to pay for a selection of media and advertisement,

and in which the intermediary means is adapted to establish an auction between the supplier making “supply offers” and the consumer making “consume offers” to establish agreed transactions between a supplier and a consumer.

By auction we mean any system in which suppliers and consumers of media are brought together to establish contracts for supplying/receiving the media.

By price we may mean a monetary value such as the amount of money that a supplier will provide media for. Alternatively it may be a time value, indicating the amount of interruptions in a media programme that a viewer will accept in any time period. In the later case the supplier will provide a supply price indicative of the amount (number or percentage) of interruptions they will provide with a selection of media. The interruptions will often comprise adverts provided by the supplier or a third party that generate revenue for a supplier and as such often have a monetary value that can be expressed in terms of time.

The intermediary means may comprise a processor for receiving offer prices and transmitting them to the suppliers/consumers to establish the auction. It may, for example, include a modem which actively sends prices to the consumers and suppliers. Alternatively, it may include a web server (or access thereto) on which is hosted a webpage to which one or more of the prices are posted. The supplier and consumer may access and update the prices on the page. The consumer means may include means for requesting the webpage for viewing.

The intermediary means may include one or more software agents which may be adaptive and which identify executable contracts which can be formed between a supplier and a consumer from the prices. Once identified the agents may execute the contracts. For example, when a consumer indicates a price for receiving media which is equal to or greater than an offer from a supplier for that media a contract between the two parties will be executed.

The supplier means may comprise a unit which may provide different supply prices for different times of the day, different types of media and different amounts of interruptions or types of interruption.

The supply means may include a processor which accesses an area of memory in which supply prices are stored and a transmitter for transmitting the supply prices to the intermediary means. This may comprise a modem perhaps.

The consumer means may include a receiver accessed by the consumer which is adapted to receive media content transmitted across the network.

The supplier means may include a data storage means for storing information representing media content that is available for supply across the network from the suppliers. The data storage means may be adapted to store media content which comprises at least one media programme and at least one advertisement, and in which at least one of the supply offer price and consume offer price depend on the amount of advertisement content to be supplied to the consumer. It may also store information indicative of combinations of programme and adverts that the supplier will offer together with a supply offer price. In this case, the supply offer price means will comprise the memory storing the information and a transmitter for sending the information to the intermediary.

The supply means and/or the intermediate means may include a transmitter adapted to transmit at least one media programme and at least one advertisement from data storage means to the consumer at a price agreed by the intermediate means from the auction.

The consumer means may include a presentation means upon which media and/or advertisements received by the receiver unit are presented to the consumer;

a selection means which is adapted to select for presentation to the consumer either advertisements or media programmes from the receiver depending upon the setting of the selection means; and

a control means operable by the consumer which permits the consumer to control the setting of the selection means in turn to vary the number of and/or duration of advertisements presented relative to the amount of media content presented within a given period of time.

The setting of the control means may determine, at least partially the “consume offer price” offered by the consumer to the intermediate means and in which the consumer unit is arranged to send back to the supplier a signal indicative of the setting of the selection means.

The transmitter may transmit at least one channel of information to the receiver, the channel comprising a media content sub-channel which carries media programmes and an advertisement sub-channel which carries advertisements. For example, each channel may comprise a media content sub-channel and an advertisement sub-channel.

A channel selection means may be provided by which the consumer can select from which channel media/advertisements are to be presented in the given period of time, the selection means selecting between presenting the information in the media sub-channel and the information in the, or one of the, advertisement sub-channels of the selected channel.

The selection means may be adapted to vary the time spent displaying media relative to the time spent displaying advertisements in a given time period. It may comprise a switch embodied in hardware or software or both and the control means control the position of the switch over time.

The supplier means may provide one or more primary markers associated with each advertisement and one or more corresponding secondary markers associated with each media programme stored in the data storage means and in which the consumers receiver unit includes means for identifying a secondary marker in a media programme and means for passing the advertisement having a primary marker associated with the secondary marker for presentation to the consumer whilst interrupting the presentation of the media programme. Each marker may include a priority value with the advertisement, the position of the selection means determining the value of a consumer selected threshold value, and the advertisement only being presented if the priority value exceeds the selected threshold value.

In one arrangement, it is envisaged that the receipt of a secondary marker by the receiver unit presents to the consumer an identifier, such as a logo on a display screen or an audible alarm, which prompts the user to either select presentation of, or de-select the presentation of, the advertisement having a primary marker that corresponds to the secondary marker.

The supplier means may include a billing unit which determines the amount that a consumer is billed for receiving information over a given time period as a function of the setting of the selection means during that time period and the price agreed through the intermediate means. The billing unit may be arranged to bill the consumer a smaller amount for time periods in which the selection means is set to present a high proportion or number of adverts in a given time period and a larger amount for a time period in which the selection unit is set to present a lower proportion or number of advertisements in that time period.

The supplier means may also be provided with a viewing time calculation unit which is adapted to record the percentage of time spent by a viewer watching advertisements during a given time period.

In accordance with a second aspect the invention provides a method of enabling a consumer to control the cost of media supplied by a media supplier in which the consumer indicates to the supplier their willingness to accept advertising content along with the supplied media and the supplier alters the amount of advertising content presented to the consumer in response to the consumers indicated willingness.

Thus, the consumer may indicate a willingness to view a lot of advertisements in which case the supplier may reduce the cost of supplying the media. The consumer may indicate a willingness to view little or no advertisements in which case the supplier may increase the cost of supplying the media. They may indicate their willingness by indicating how much they will pay to receive a programme with and/or without adverts.

In the system and method of the first and second aspects of the invention, in at least one embodiment, the supplier may alter the mix of advertisements to media programmes prior to transmitting rather than the consumer selecting the mix after transmission depending upon the preferences expressed by the consumer. It provides greater control to the supplier but at the cost of having to transmit possibly unique information to each consumer.

The method may comprise establishing an intermediary between the consumer and the supplier who receives both media programmes and advertisements as well as the signals from consumers indicating the amount of advertisements they wish to view/listen to.

The supplier and/or the intermediary may alter the amount that a consumer is billed for being presented with media programmes as a function of the amount or the type of advertisements that the consumer agrees to view/listen to. Thus, as an example, a consumer may be provided with lower cost access to a sports event by indicating that they will be interrupted by advertisements and at a higher cost if they indicate that they want to view less or no advertisements.

The amount that is billed may be varied as a function of the number of consumers who are presented with the media programme. For instance, if a large number of consumers ask to watch a media programme they may be billed a lower amount than they are for a media programme which has only got a small number of consumers asking to view it.

The supplier and/or the intermediary may transmit to the consumer a “supply offer” price at which media programmes on any one channel may be viewed, or a particular media programme or time slot.

The consumer may be provided with a “consume offer” price at which they are prepared to pay to view media programmes on any one channel, or a particular media programme or time slot.

The intermediary may act as an auctioneer between the supplier making “supply offers” and the consumer making “consume offers” to establish agreed transactions between a supplier and a consumer. This allows a consumer to agree through the intermediary to accept more adverts to meet their offer price.

The consumer and/or the supplier may also transmit to one another directly or through an intermediary the amount of advertising they will accept/are prepared to send for a given price. Again, an auction process may be used to match the consumer's demands to those of the suppliers.

The method may further include providing details of the socio-economic group of the consumer to the supplier as part of the auction process. This is advantageous as the supplier may be prepared to provide media programmes at a lower price if they can include one or more advertisements that are targeted specifically at a particular socio-economic group, thus reducing the cost to the consumer.

In accordance with a third aspect the invention provides an intermediary means for facilitating the supply of media from a number of suppliers to a number of consumers across a network comprising:

supply offer receiving means for receiving from a number of suppliers a “supply offer” price indicative of the price that a supplier is offering to supply a combination of media content and/or advertisements to consumers connected to the network;

consume offer receiving means for receiving from a number of consumers a “consume offer” price indicative of the price that a consumer is prepared to pay for a selection of media and advertisement, and

auction means for establishing an auction between the or each supplier making a “supply offer” and the or each consumer making “consume offers” to establish agreed prices for transactions between a supplier and a consumer for the supply of a selection of media across the network.

In accordance with a fourth aspect the invention provides a system for providing media programmes and advertising content from a supplier to a consumer comprising:

a transmitter adapted to transmit at least one media programme and at least one advertisement from the supplier to the consumer;

a receiver accessed by the consumer, which is adapted to receive the programmes and advertisements transmitted by the supplier from the transmission unit;

a presentation means upon which media and/or advertisements received by the receiver unit are presented to the consumer;

a selection means which is adapted to select for presentation to the consumer either advertisements or media programmes from the receiver depending upon the setting of the selection means; and

a control means operable by the consumer which permits the consumer to control the setting of the selection means in turn to vary the number of and/or duration of advertisements presented relative to the amount of media content presented within a given period of time.

The invention therefore provides apparatus in which a consumer can, for example, choose to be presented with a large amount of media programming and little advertising programmes in a given time period or to do the opposite and be presented with lots of advertisements and little media in that same period. In the prior art, this has not been possible as the consumer has had no control over the timing and amount of advertisements which are transmitted.

The transmitter may transmit at least one channel of information to the receiver unit, the channel comprising a media content sub-channel which carries media programmes and an advertisement sub-channel which carries advertisements. The media and the advertisements may be transmitted simultaneously.

Preferably, more than one channel is transmitted, optionally with the channels being transmitted simultaneously. Each channel may comprise a media content sub-channel and an advertisement sub-channel. More than one, and possibly all of the channels may share a common advertisement sub-channel. Some channels, or perhaps all channels, may include their own unique advertisement sub-channels. One or more of the channels may include multiple associated advertising sub-channels.

A single supplier may provide only one of the channels or more than one. A different supplier may provide one or more of the remaining channels. Therefore, the system may include more than one transmission unit.

The apparatus may further include a channel selection means by which the consumer can select from which channel media/advertisements are to be presented in the given period of time. In this case, the selection means may select between presenting the information in the media sub-channel and the information in the, or one of the, advertisement sub-channels of the selected channel.

The selection means may be adapted to vary the time spent displaying media relative to the time spent displaying advertisements in a given time period. Alternatively, it may vary the number and/or duration of advertisements displayed during and/or before and/or after the presentation of a selected programme. It may comprise a switch embodied in hardware or software or both. The control means may control the position of the switch over time.

For example, where the presentation means comprises a television display a consumer may want to watch a football match. They select the channel that is showing the match at the start time indicated by the channel. They can then set the selection means to indicate that they want little or no adverts or to indicate that they want lots of adverts. If the match is shown live, the consumer watching the adverts will miss some of the live coverage compared with a consumer who does not want to watch adverts. If it is pre-recorded, the match may be time shifted so that a customer who watches half an hour of adverts finishes viewing the match half an hour later than a customer who has selected to watch no adverts.

The consumer may be able to control the setting of the selection means in real time or must select a setting prior to the start of receiving a media programme. For instance, in the first case they may decide not to be interrupted during an exciting football match or decide half way through that the game can be interrupted to reduce the cost of watching a game that is becoming uninteresting.

The supplier may transmit one or more primary markers associated with each advertisement and one or more corresponding secondary markers associated with each media programme. The consumer's receiver unit may include means for identifying a secondary marker in a media programme and may pass the advertisement having a primary marker associated with the secondary marker for presentation to the consumer whilst interrupting the presentation of the media programme. This allows the supplier to control which adverts appear where in a programme.

An advertisement may not be presented to the consumer if the selection means is set in a position in which the consumer indicates that no advertisements are to be presented. Thus, the secondary marker may be ignored.

In a refinement, each marker may include a priority value with the advertisement, the position of the selection means determining the value of a consumer selected threshold value, and the advertisement may only be presented if the priority value exceeds the selected threshold value.

In a further refinement, the receipt of a secondary marker by the receiver unit may present to the consumer an identifier, such as a logo on a display screen or an audible alarm, which prompts the user to either select presentation of, or de-select the presentation of, the advertisement having a primary marker that corresponds to the secondary marker.

A second transmission unit may be provided which is arranged to send back to the supplier a signal indicative of the setting of the selection means. This signal therefore provides feedback to the supplier indicating the consumers preference for watching adverts or media. This may most conveniently be provided at the consumer end. For example, it may be integrated into a single unit with a suitable receiver and optionally the selection means.

By sending a signal back to the supplier it is possible to provide many refinements to the operation of the system which may benefit both the supplier and the customer.

In one refinement the supplier may have a billing unit which determines the amount that a customer is to be billed for viewing a channel over the given time period as a function of the setting of the selection means during that time period.

The supplier may also provide a viewing time calculation unit which is adapted to record the percentage of time spent by a viewer watching advertisements during a given time period. This may be useful to the supplier in attracting advertisers as it allows the supplier to show how often adverts are viewed.

The billing unit may be arranged to bill the consumer a smaller amount for time periods in which the selection means is set to present a high proportion or number of adverts in a given time period and a larger amount for a time period in which the selection unit is set to present a lower proportion or number of advertisements in that time period.

The transmitter may be connected to the customer receiver unit across any one of a range of different types of network. The format in which the information is transmitted will depend, to a large extent, on the choice of network selected.

For example, the transmitter may transmit information as a modulated radio wave. The radio waves may be emitted from an antenna attached to a broadcast tower. This technique is commonly referred to as a “terrestrial” broadcast. Alternatively, they may be transmitted via a satellite with an up-link from the transmitter unit to the satellite and a downlink from the satellite to the receiver unit. This is commonly referred to as a “satellite” broadcast.

In a further alternative the transmitter may send information to the consumers receiver across a wire or cable. This is commonly referred to a “cable” broadcast.

The media programme and advertisement preferably comprise both a visual and an aural component to define a television broadcast. Alternatively, it may comprise a radio programme, which may consist solely of aural information. It may comprise multimedia programmes such as computer games or interactive videos.

The receiver and the selection means and the second transmission unit may be integrated as a single device. For instance, they may be accommodated within a common housing that can be conveniently located by a television or radio set.

In an alternative they may be combined with a display to form a single integrated device such as a television set.

An input device, such as a keypad or remote control may be provided or part of the control means which enables the customer to alter the setting of the selection unit.

In a further refinement the selection device may be adapted to store details of a customers selection preferences in an area of memory and to automatically control the setting of the selection device as a function of the stored preferences. For example, the selection means may automatically be set to a setting, which reduces the advertisement content when a customer's favourite programme or type of programme is transmitted.

To enable the selection unit automatically to adjust the setting of the or each or selected ones of the broadcast media programmes may include information which indicates the type of programme to the receiver unit. For instance, a separate signal indicating the type of programme or the name of the programme may be sent via a sub-channel of the broadcast channel.

In accordance with a fourth aspect the invention provides apparatus for use by a consumer to receive media programmes and advertising content from a supplier comprising:

a receiver which is adapted to receive one or more programmes transmitted by the supplier from the transmission unit which include both media programmes and advertisements;

an output means which sends the received programmes to a presentation means for presentation to the consumer;

a selection means which is adapted to select for presentation to the consumer either advertisements or media programmes from the receiver depending upon the setting of the selection means;

a control means operable by the consumer which permits the consumer to control the setting of the selection means in turn to vary the amount of advertisements presented relative to the amount of media content presented within a given period of time; and

a transmitter adapted to transmit to the supplier or another party a signal indicative of the setting of the selection means over time.

The presentation means may comprise either or both of a display screen and a loudspeaker for presenting visual and audio information sent by the output means. For example, the display may be a cathode ray tube or liquid crystal (LCD) display. This presentation means may be combined with the receiver and the output means in a single unit.

The receiver may receive transmitted information that comprises a media-programme sub-channel and an advertisement sub-channel. It may receive from only one of these at a time dependent upon the setting of the selection means. Alternatively, it may receive from both simultaneously.

It may also receive secondary markers in the programme media which indicate associated advertisements identified by primary markers transmitted alongside or embedded within the transmitted advertisements.

The receiver may be adapted to display an indication to the consumer when a primary marker is received and the consumer may choose to display or not display the advertisement. The setting of the selection means may determine whether or not an advertisement is displayed dependent upon information contained within the secondary marker.

For example, the marker may indicate the priority in which an advertisement is to be preferentially displayed over other advertisements. If a consumer sets the selection means to indicate very little advertising content is wanted only those adverts associated with high priority markers will be presented. If the selection means is set to indicate that more adverts should be presented then those of a lower priority will also be presented.

The transmitter may transmit a signal, which is updated at regular intervals and encodes the setting of the selection means. Alternatively, it may send a signal whenever the setting of the selection means is altered by the consumer. It may comprise a modem for the transmission of a signal over a telecommunications network.

The transmitter may also transmit information relating to the viewing and/or listening preferences of the consumer. It may also transmit information representative of the socioeconomic group of the consumer. For example, it may transmit details of the residential address of the consumer. This may be used by the supplier to determine the price charged to the consumer to view media and may also be used to determine which advertisements are sent to the consumer.

There will now be described, by way of example only, one embodiment of the present invention with reference to the accompanying drawings of which:

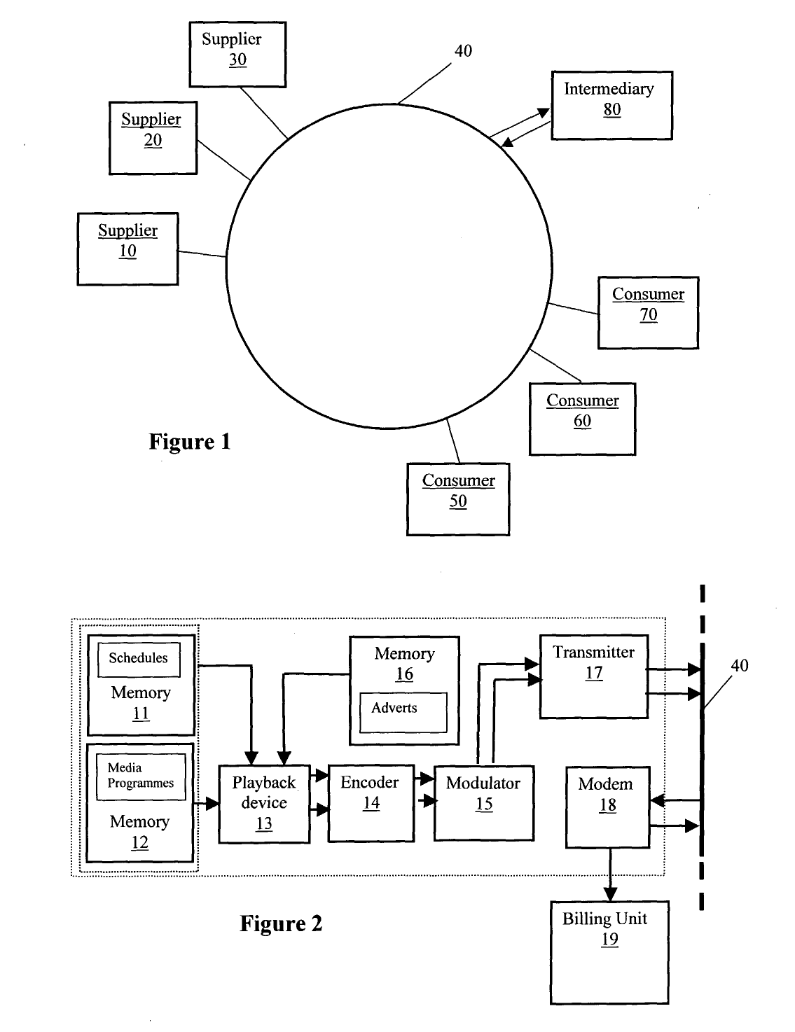

FIG. 1 is an overview of an apparatus for use in supplying media and programmes and advertisements from suppliers to consumers;

FIG. 2 is a detailed schematic of the supplier means provided at the supplier;

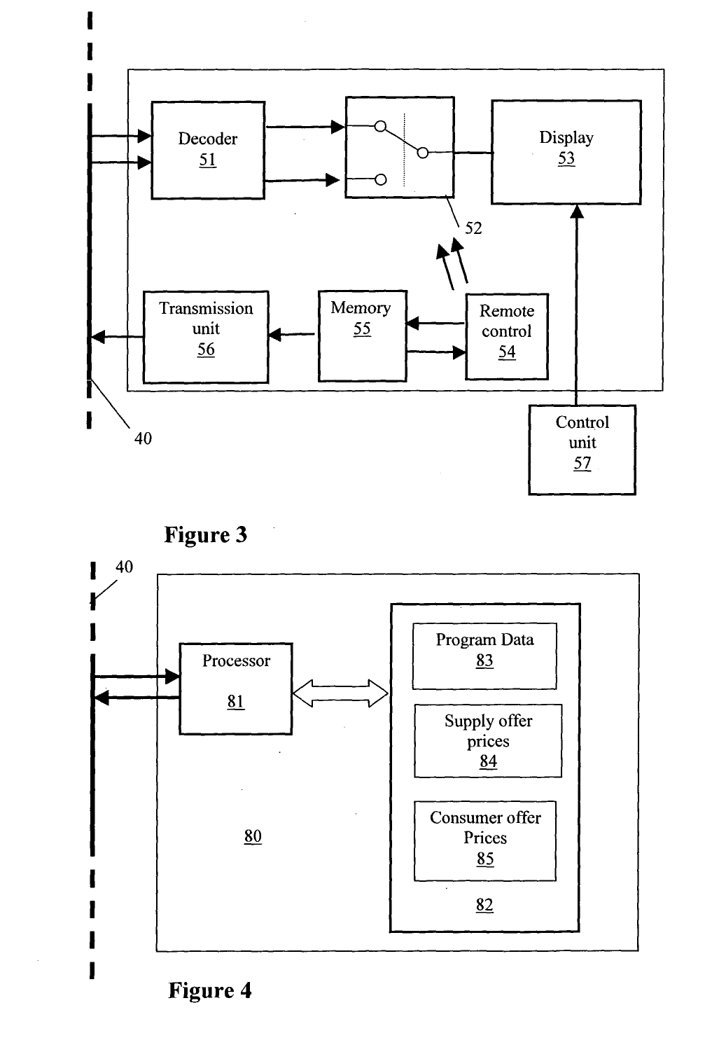

FIG. 3 is a detailed schematic of the consumer means provided at the consumer; and

FIG. 4 is a detailed view of an intermediary means which provides an auction of prices between the suppliers and consumers of FIG. 1.

As illustrated in FIG. 1 apparatus for use by three suppliers and a group of three consumers for the presentation of media programmes across a network comprises a plurality of supplier means comprising units 10,20,30 connected across a transmission medium 40 to a plurality of consumer means comprising 50,60,70. Of course, many more suppliers and a lot more consumers may be included in the apparatus. In the example shown the transmission medium comprises an optical fibre cable network running between the commercial premise of each supplier and the residential houses of each consumer.

Each supplier means comprises a transmitter provided at a premises owned by a respective supplier or by an intermediary company that has arranged to transmit media content including programmes and advertisements at the suppliers request. Each consumer unit 50,60,70 includes a receiver which is provided at the consumer's premises and enables the consumer to access the transmitted programmes from the transmission media. Each consumer unit 50,60,70 also produces an output signal that can be fed to a presentation means such as a television 80,90 or a radio 100.

FIG. 2 of the accompanying drawings illustrates in more detail a typical consumer means 10 for use in the apparatus of FIG. 1. These comprise one piece units which comprise a small area of digital memory 11 in which a schedule of programmes to be broadcast is stored. Each programme that is required to fill the schedule is either pre-recorded and stored in a second area of memory until it is to be broadcast or is transmitted live. A larger, second, area of memory 12 is also provided which may comprise magnetic tapes or optical discs such as a DVD on which the programmes are stored. Throughout the duration of a transmission the stored schedule is used to ensure that the programmes are transmitted in the correct order and at the correct time. A copy of the schedule is also released in advance to the consumer so that they can decide which programmes they want to view.

To transmit a programme to a viewer the appropriate disc or tape as indicated by the schedule is placed into a playback device (either a tape player or disc player) that reads the data from the memory 12 and outputs a suitable data signal to an encoder 14, which converts the programme signal into a format which is suitable for transmission. In this example the encoding is achieved by a modulator 15 which modulates the programme information onto a carrier frequency. The carrier frequency will be unique to a given transmission from the supplier. Thus, a single supplier can simultaneously transmit more than one transmission by using different carrier frequencies—each transmission being considered to comprise a channel of programmes.

In addition to the areas of memory 11,12 (videos, hard disk DVD's etc) which store media programmes the apparatus also includes an additional area of memory 16 which stores advertisement programmes. Each advertisement, typically around 30 seconds in length, is provided by an advertiser and is stored in a memory such as a DVD or hard disk. The adverts can also be played and passed to the encoder where they are modulated with a carrier frequency, which is related to the carrier frequency of a programme channel to form a pair of sub-channels. Thus, the encoder 14 produces a pair of sub channels, which comprise a programme channel and a related advert channel.

The two sub-channels are passed from the encoder 14, the modulator 18 and then onto a transmitter 17 which sends the information contained in the sub-channels across the network. The supplier therefore transmits one or more pairs of channels to the consumers across the transmission medium. In the example of FIG. 1, the three suppliers may be assumed to send one channel (a pair of sub-channels) onto the network 40 at any given time.

A typical consumer means 50 for use by a consumer is illustrated in more detail in FIG. 3 of the accompanying drawings. The consumer means 50 is in many ways similar to any receiver unit available today for use in receiving information from a cable network. Indeed the reader is directed to the teachings that are commonly known in the art for the construction of the basic elements of the unit.

In the illustrated example of FIG. 3, the consumer means 50 comprises a multi-channel receiver, which includes a decoder 51 that can be tuned by the consumer to any pair of sub-channels, which make up one of the three broadcast channels and decode the information in each of the pairs of channels. This allows the consumer to select to receive information from any one of the three channels.

The two sub-channels of decoded information output from the decoder are passed to a selection means 52, which in the illustrated embodiment comprises a two-position sub-channel selection switch 52. The switch 52 may be set to one of two positions by a control unit 57. In a first position the information output from the decoder 51 corresponding to the media sub-channel is output from the switch 52. In the second position the information sent across the advert sub-channel is output from the switch. The setting of the switch at any given time therefore determines whether it is to output media programmes or advertisements.

The output signal that has passed through the switch is fed to a presentation means 53, in this case a cathode ray tube display of a television set for viewing by the consumer.

The consumer means 50 includes a selection switch 52 and control means 53 which selects between media and advertisements and this is made possible by the unique format in which the supplier sends the adverts separate from the media programmes. Although in this example the media and adverts are sent as separate sub channels they could be distinguished in other ways.

The control means 53 provides the consumer with control over the position of the selection switch. As shown, the control means comprises a processing circuit, which receives manually selected control signals from a remote control 54 that communicates with the processing circuit using encoded infrared signals. The control unit also incorporates a degree of automatic selection, which will assist in controlling the switch.

The control means includes an area of electronic memory 55 associated with the processing circuit which stores one or more setting values which indicate the setting required by the user of the switch. A setting value may take any one of a range of values between a minimum value and a maximum value and the value may be fully controlled by the consumer, for instance from the remote control. The minimum value may indicate that the consumer does not want to view any adverts, the maximum indicating that the customer wants to see as many adverts as possible. The processing circuit regularly accesses the stored value and uses it to determine the correct position of the selection means.

In a simple arrangement, a minimum value will cause the control unit processing circuit 53 to produce a signal, which causes the selection switch 52 to permanently provide content from the media sub-channel to the output of the switch. If the maximum value is stored the switch will always supply content from the advert channel to the output of the switch.

For settings in between the extremes the processor 53 supplies a varying control signal to the switch controller such that the setting of the switch is modulated over time. The form of modulation will depend on the type of adverts and media that is transmitted.

The stored setting value in the memory 55 may be altered by the viewer using the remote controller. A button on the remote marked “more adverts” may be pressed which will cause the processor to increase the stored setting value. A different button on the remote marked “less adverts” may be pressed by the consumer, which will cause the processor to decrease the stored setting value.

The consumer means 50 also includes a transmission unit 56, which is adapted to transmit a signal back to the supplier indicative of the stored setting value. As shown in FIG. 3 this comprises a modem, which dials up the supplier across the cable network 40. The signal includes information identifying the channel viewed at any given time and the setting of the selection means at that given time. This provides a profile of the media and adverts presented to the consumer. The information used to produce the signal is retrieved from the memory.

The supplier means 10, shown in FIG. 2, also includes a modem 18, which receives the signals sent back from the viewer, and from any other viewers of the transmitted broadcasts. An output of the supplier's modem is passed to a separate billing unit 19, which comprises a memory in which the setting value of the customer over time is stored. This value can be used by an accounts department to determine the amount that the consumer is to be billed for the programmes and adverts that they have viewed.

The amount of the bill will depend on the time and nature of the programmes that have been viewed and also upon the amount of adverts that have been viewed. Hence, a viewer can reduce their bills by selecting “view more adverts”. Alternatively, if they are happy to view more adverts they can reduce their bill.

Also shown in FIG. 1 is an intermediary means which is connected across the network to all of the suppliers and consumers. Whilst the arrangement of the network in FIG. 1 permits every supplier to communicate directly with every consumer an alternative arrangement of network may require each supplier to send and receive information through the intermediary means to the consumers. The intermediary means is shown in more detail in FIG. 4 of the accompanying drawings.

The intermediary means comprises a processor, an area of physical memory which stores blocks of data representing instructions defining a computer program. The intermediary also includes a separate area of memory which stores blocks of data indicative of “supply offer” prices received from suppliers and “consume offer” prices received from consumer units. The program stored on the memory, when executed by the processor instructs the intermediary to provide an auction between the suppliers and the consumers using the “supply offer” and “consume offer” information stored in the memory. The purpose of the auction, which in at least one arrangement is carried out in real time is to establish agreed prices for the supply of information to the consumers. The auction process provides the consumers with control over the prices set by the suppliers.

The intermediary means supplies the “supply offer” price information to the consumer units along with some information describing the media which can be received for the “supply offer” price. This information could, for example, be a description of a programme that is on offer along with its run time, the time it will be available for receipt and the amount of advertisements that are included. The identity of the supplier may also be included. This information is then presented to the consumer on the display of the consumer unit, possibly on demand.

Having digested the presented supply offer information a consumer may indicate how much he or she is prepared to pay for a portion of the media on offer and this information is sent back to the intermediate means across the network. In one arrangement, the intermediate means may receive from the consumer information indicative of the setting of the control switch to indicate the proportion of advertisements that the consumer is willing to accept along with a signal identifying the portion of media they wish to receive and a “consume offer” price. This is the price the consumer is prepared to pay to receive the media. The setting of the selection switch may be used to define the “consume price” as a function of an “offer price” set by a consumer—more adverts setting a consume price below the offer price and less setting a higher consume price. Alternatively, a keypad may be provided so that the consumer can enter a consume offer price directly to the consumer unit.

The intermediary passes the consume prices back to the supplies who can then choose a new offer price if they wish to do so. They may do this to encourage more consumers to wish to receive the media. The new “supply offer” prices can then be passed through the intermediary back to the consumers and so on and so forth. The consumer may reject this new price or indicate that they may accept more adverts and provide a slightly higher consume price. Otherwise, a consumer can agree with the supply offer price (and the supplier with a consume offer price) at any time, whereupon the auction is closed or the supply offer price rejected.

By providing the intermediary a market is established in which market forces such as supply and demand for programmes and advertisements will affect the price that a consumer must pay for a media programme. This provides greater power to the consumer and establishes healthy competition amongst suppliers who wish to put their programmes and advertisements before a consumer. For maximum benefit to consumers and suppliers it is envisaged that the auction will take place in real time up to the allotted time of transmission of media programmes.

1. A system for supplying media provided by one or more suppliers to a number of consumers across a network through an intermediary means comprising:
a supplier means which includes supply offer price means for providing to said intermediary means a “supply offer” price indicative of a price that said supplier is offering to supply a combination of media content and/or advertisements to said consumers connected to the network;
a consumer means which includes a consume offer supply means for providing to said intermediary means a “consume offer” price indicative of a price that said consumer is prepared to pay for a selection of media and advertisement,
and wherein said intermediary means is adapted to establish an auction between said supplier making “supply offers” and said consumer making “consume offers” to establish agreed transactions between said supplier and said consumer.

2. The system of claim 1 in which said intermediary means comprises a processor for receiving offer prices and transmitting them to said suppliers/consumers to establish said auction.

3. The system of claim 1 wherein said intermediary means includes one or more software agents which identify executable contracts which can be formed between said supplier and said consumer.

4. The system of claim 1 wherein consumer means includes a receiver accessed by said consumer which is adapted to receive media content transmitted across said network.

5. A system according to claim 1 wherein said supplier means includes a data storage means for storing information representing media content that is available for supply across said network from said suppliers and in which said data storage means is adapted to store media content which comprises at least one media programme and at least one advertisement, and in which at least one of said supply offer price and consume offer price depend on an amount of advertisement content to be supplied to said consumer.

6. The system of claim 1 wherein at least one of said supplier means and said intermediate means includes a transmitter adapted to transmit at least one media programme and at least one advertisement from data storage means to said consumer at a price agreed by said intermediate means from said auction.

7. The system of claim 1 wherein said consumer means includes
a presentation means upon which media and/or advertisements received by said consumer means are presented to the consumer;
a selection means which is adapted to select for presentation to said consumer either advertisements or media programmes from said supplier depending upon the setting of the selection means; and
a control means operable by said consumer which permits said consumer to control a setting of said selection means in turn to vary at least one of a number of and duration of advertisements presented relative to an amount of media content presented within a given period of time.

8. The system of claim 7 in wherein said setting of said control means determines, at least partially said “consume offer price” offered by said consumer to said intermediate means and wherein said consumer unit is arranged to send back to said supplier a signal indicative of a setting of said selection means.

9. A system according to claim 6 wherein said transmitter is adapted to transmit at least one channel of information to said receiver, said channel comprising a media content sub-channel which carries media programmes and an advertisement sub-channel which carries advertisements.

10. A system according to claim 9 wherein each channel comprises a media content sub-channel and an advertisement sub-channel.

11. A system according to claim 9 which further includes a channel selection means by which said consumer can select from which channel media/advertisements are to be presented in the given period of time, said selection means selecting between presenting said information in said media sub-channel and said information in at least one of said advertisement sub-channels of a selected channel.

12. A system according to claim 1 wherein said supplier means provides one or more primary markers associated with each advertisement and one or more corresponding secondary markers associated with each media programme and in which said consumer means includes means for identifying a secondary marker in a media programme and means for passing an advertisement having a primary marker associated with said secondary marker for presentation to said consumer whilst interrupting presentation of said media programme.

13. A system according to claim 12 wherein each marker includes a priority value with said advertisement, a position of said selection means determining a value of a consumer selected threshold value, and said advertisement only being presented if said priority value exceeds said selected threshold value.

13. A system according to claim 11 wherein receipt of a secondary marker by said receiver presents to said consumer an identifier, such as a logo on a display screen or an audible alarm, which prompts said user to either select presentation of, or de-select presentation of, am advertisement having a primary marker that corresponds to said secondary marker.

14. A system according to claim 1 wherein said consumer means includes
a presentation means upon which media and/or advertisements received by said consumer means are presented to the consumer;
a selection means which is adapted to select for presentation to said consumer either advertisements or media programmes from said supplier depending upon the setting of the selection means; and
a control means operable by said consumer which permits said consumer to control a setting of said selection means in turn to vary at least one of a number of and duration of advertisements presented relative to an amount of media content presented within a given period of time;
and wherein said supplier means includes a billing unit which determines an amount that a consumer is billed for receiving information over a given time period as a function of a setting of said selection means during that time period and a price agreed through the intermediate means.

15. A system according to claim 1 wherein said consumer means includes
a presentation means upon which media and/or advertisements received by said consumer means are presented to the consumer;
a selection means which is adapted to select for presentation to said consumer either advertisements or media programmes from said supplier depending upon the setting of the selection means; and
a control means operable by said consumer which permits said consumer to control a setting of said selection means in turn to vary at least one of a number of and duration of advertisements presented relative to an amount of media content presented within a given period of time;
and wherein said selection device is adapted to store details of a customers selection preferences in an area of memory and to automatically control a setting of said selection device as a function of said stored customer selection preferences.

16. A method of enabling a consumer to control the cost of media supplied by a media supplier in which said consumer indicates to said supplier their willingness to accept advertising content along with said supplied media and said supplier alters an amount of advertising content presented to said consumer in response to said consumers indicated willingness.

17. A method according to claim 16 wherein said intermediary transmits to said consumer a “supply offer” price at which a supplier is initially willing to offer media programmes to a consumer, or a particular media programme or time slot, said consumer provides a “consume offer” price which they are initially prepared to pay for media programmes on offer from a supplier, or a particular media programme or time slot, and said intermediary acts as an auctioneer between said supplier making “supply offers” and said consumer making “consume offers” to establish agreed prices for transactions between a supplier and a consumer.

18. A method according to claim 16 wherein at least one of said supplier and said intermediary alter an amount that a consumer is billed for being presented with media programmes as a function of at least one of an amount and a type of advertisements that said consumer agrees to view/listen to.

19. A method according to claim 16 wherein said auction takes place in real time between a supplier and a consumer.

20. A method according to claim 19 wherein said consumer and said supplier also transmit to one another directly or through an intermediary the amount of advertising they will accept/are prepared to send for a given price along with their “supply offer” price or “consume offer” price for a selection of programme media.

21. A method according to claim 16 which further includes providing details of the socioeconomic group of the consumer to the supplier.

22. An intermediate unit for facilitating the supply of media from a number of suppliers to a number of consumers across a network comprising:
supply offer receiving means for receiving from a number of suppliers a “supply offer” price indicative of a price that a supplier is offering to supply a combination of media content and/or advertisements to consumers connected to the network;
consume offer receiving means for receiving from a number of consumers a “consume offer” price indicative of a price that a consumer is prepared to pay for a selection of media and advertisement, and
auction means for establishing an auction between the or each supplier making a “supply offer” and the or each consumer making “consume offers” to establish agreed prices for transactions between a supplier and a consumer for supply of a selection of media across said network.

23. A system for providing media programmes and advertising content from a supplier to a consumer comprising:
a transmitter adapted to transmit at least one media programme and at least one advertisement from said supplier to said consumer;
a receiver accessed by said consumer, which is adapted to receive programmes transmitted by said supplier from said transmitter;
a presentation means upon which media and/or advertisements received by said receiver unit are presented to said consumer;
a selection means which is adapted to select for presentation to said consumer either advertisements or media programmes from said receiver depending upon a setting of said selection means; and
a control means operable by said consumer which permits said consumer to control a setting of said selection means in turn to vary at least one of number of and duration of advertisements presented relative to an amount of media content presented within a given period of time.

24. A system according to claim 23 wherein said transmitter transmits at least one channel of information to said receiver, the channel comprising a media content sub-channel which carries media programmes and an advertisement sub-channel which carries advertisements.

25. A system according to claim 24 in which each channel comprises a media content sub-channel and an advertisement sub-channel.

26. A system according to claim 23 wherein said supplier transmits one or more primary markers associated with each advertisement and one or more corresponding secondary markers associated with each media programme and wherein said consumers receiver includes means for identifying a secondary marker in a media programme and means for passing an advertisement having a primary marker associated with said secondary marker for presentation to said consumer whilst interrupting presentation of said media programme.

27. A system according to claim 26 wherein each marker includes a priority value associate with an advertisement, a position of said selection means determining a value of a consumer selected threshold value, and said advertisement only being presented if said priority value exceeds said selected threshold value.

28. A system according to claim 26 wherein receipt of a secondary marker by said receiver presents to said consumer an identifier, such as a logo on a display screen or an audible alarm, which prompts a consumer to either select presentation of, or de-select the presentation of, an advertisement having a primary marker that corresponds to the secondary marker.

29. A system according to claim 23 wherein said selection means is adapted to store details of a customers selection preferences in an area of memory and to automatically control a setting of said selection means as a function of said stored customer selection preferences.

30. A system according to claim 24 which further includes a channel selection means by which said consumer can select from which channel media/advertisements are to be presented in a given period of time, said selection means selecting between presenting information in said media sub-channel and information in at least one advertisement sub-channel of said selected channel.

31. A system according to claim 24 wherein said selection means is adapted to vary time spent displaying media relative to time spent displaying advertisements in a given time period.

32. A system according to claim 23 wherein a second transmitter is provided which is arranged to send back to said supplier a signal indicative of a setting of said selection means.

33. A system according to claim 32 wherein said supplier has a billing unit which determines an amount that a customer is to be billed for viewing a channel over a given time period as a function of a setting of said selection means during that time period.

34. A system according to claim 33 wherein said billing unit is arranged to bill said consumer a smaller amount for time periods in which said selection means is set to present a high proportion or number of adverts in a given time period and a larger amount for a time period in which said selection means is set to present a lower proportion or number of advertisements in that time period.

35. A system according to claim 23 wherein supplier is provided with a viewing time calculation unit which is adapted to record a percentage of time spent by a viewer watching advertisements during a given time period.

36. Apparatus for use by a consumer to receive media programmes and advertising content from a supplier comprising:
a receiver which is adapted to receive one or more programmes transmitted by said supplier from said transmission unit which include both media programmes and advertisements;
an output means which sends the received programmes to a presentation means for presentation to said consumer;
a selection means which is adapted to select for presentation to said consumer either advertisements or media programmes from said receiver depending upon a setting of said selection means;
a control means operable by said consumer which permits said consumer to control a setting of said selection means in turn to vary an amount of advertisements presented relative to an amount of media content presented within a given period of time; and
a transmitter adapted to transmit to said supplier or another party a signal indicative of a setting of said selection means over time, and wherein said receiver receives transmitted information that comprises a media-programme sub-channel and an advertisement sub-channel.

37. Apparatus according to claim 36 which is adapted to receive secondary markers in the programme media which indicate associated advertisements identified by primary markers transmitted alongside or embedded within transmitted advertisements.

38. Apparatus according to claim 37 wherein said receiver is adapted to display an indication to said consumer when a secondary marker is received and said consumer may choose to display or not display said advertisement.

39. Apparatus according to claim 37 wherein said marker indicates a priority in which an advertisement is to be preferentially displayed over other advertisements.

40. Apparatus according to claim 36 wherein said transmitter transmits a signal, which is updated at regular intervals and encodes the setting of the selection means.

41. Apparatus according to claim 36 wherein said transmitter also transmits information relating to the viewing and/or listening preferences of the consumer.

42. Apparatus according to claim 36 wherein said transmitter transmits details of the residential address of the consumer.
